(19) United States
(12) Patent Application Publication
(10) Pub. No.: US 2026/0070477 A1
(43) Pub. Date: Mar. 12, 2026

(54) HOIST CONTROL FOR DUMP BODIES OF HAULING MACHINES

(71) Applicant: Caterpillar Inc., Peoria, IL (US)

(72) Inventors: Cameron Thomas Lane, Oro Valley, AZ (US); Michael D. Hudson, Tucson, AZ (US); Karl Paul Schneider, Decatur, IL (US); Steven Conrad Budde, Dunlap, IL (US); David William Engelhardt, Tucson, AZ (US); Andrew John Olson, Vail, AZ (US); Luc Anani Agbekodo, San Tan Valley, AZ (US); Harry Paul Newton, Sahaurita, AZ (US)

(73) Assignee: Caterpillar Inc., Peoria, IL (US)

(21) Appl. No.: 18/828,183

(22) Filed: Sep. 9, 2024

(51) Int. Cl. B60P 1/16

(52) U.S. Cl. CPC B60P 1/162

(57) ABSTRACT

A method for controlling a hoisting mechanism for a movement of a dump body between a rest condition and a raised condition relative to a frame. The method includes receiving a request to vary the dump body between the rest condition and the raised condition; determining a criteria for actuating the hoisting mechanism corresponding to the request, the criteria including an actuation direction and an actuation speed for a fluid actuator of the hoisting mechanism; moving a valve to a predefined position based on the actuation direction to set a direction of movement of the dump body; and controlling a state of the valve in the predefined position of the valve and an operational speed of a pump supplying the fluid flow to the valve based on the actuation speed to set a rate of movement of the dump body along the direction of movement.

### TECHNICAL FIELD

The present disclosure relates to hauling machines, including dump trucks, such as large mining trucks and/or off-highway trucks. More particularly, the present disclosure relates to system and a method for controlling a hoisting mechanism of a truck bed of a dump truck.

### BACKGROUND

Work machines, such as dump trucks, are commonly used to transfer a payload between multiple locations of a worksite. Such work machines generally include an operator cab with various input devices. The input devices may be accessible by operators stationed within the operator cab for an operation of the work machine, e.g., to move the work machine. Such work machines may also include a dump body or a truck bed in which the payload may be received for the transfer. For achieving the payload transfer, the work machine may be moved and/or the truck bed may be appropriately articulated between rest and raised conditions.

Articulating a truck bed often includes the use of one or more actuators, e.g., hydraulic actuators. For example, to achieve truck bed articulation, the actuators may be switched between an extended position and a retracted position so as to correspondingly move the truck bed between the rest and raised conditions. While switching the actuators, various input devices (e.g., a throttle of the work machine) are used to control factors, such as a speed of the switching and/or a direction of the switching, but such usage often results in excess and/or undue power consumption, resulting in an inefficient articulation operation.

U.S. Pat. No. 9,316,236 relates to a hydraulic driving apparatus provided in a working machine, such as a crane, to move a load, such as a suspended load, in the same direction as a self-weight falling direction of the load.

### SUMMARY OF THE INVENTION

In one aspect, the disclosure is directed to a method for controlling a hoisting mechanism for a movement of a dump body between a rest condition and a raised condition relative to a frame. The method includes receiving, by a controller, a request to vary the dump body between the rest condition and the raised condition. The method includes determining, by the controller, a criteria for actuating the hoisting mechanism corresponding to the request. The criteria includes an actuation direction and an actuation speed for a fluid actuator of the hoisting mechanism. Further, the method includes moving, by the controller, a valve, facilitating selective fluid flow with respect to a first chamber and a second chamber of the fluid actuator, to a predefined position based on the actuation direction to set a direction of movement of the dump body between the rest condition and the raised condition. Furthermore, the method includes controlling, by the controller, each of a state of the valve in the predefined position of the valve and an operational speed of a pump supplying the fluid flow to the valve based on the actuation speed to set a rate of movement of the dump body along the direction of movement.

In another aspect, the disclosure relates to a system for controlling a hoisting mechanism for a movement of a dump body between a rest condition and a raised condition relative to a frame. The system includes an input device and a controller. The input device is configured to be moved to a desired input location of a plurality of input locations to generate a request. Corresponding requests may be generated when the input device moves to the plurality of input locations. The controller is configured to receive the request to vary the dump body between the rest condition and the raised condition. The controller is also configured to determine a criteria for actuating the hoisting mechanism corresponding to the request. The criteria includes an actuation direction and an actuation speed for a fluid actuator of the hoisting mechanism. The controller moves a valve, facilitating selective fluid flow with respect to a first chamber and a second chamber of the fluid actuator, to a predefined position based on the actuation direction to set a direction of movement of the dump body between the rest condition and the raised condition. Furthermore, the controller is configured to control each of a state of the valve in the predefined position of the valve and an operational speed of a pump supplying the fluid flow to the valve based on the actuation speed to set a rate of movement of the dump body along the direction of movement.

In yet another aspect, the disclosure is directed to a hauling machine. The hauling machine includes a frame and a dump body supported on the frame. The hauling machine also includes a hoisting mechanism for moving the dump body between a rest condition and a raised condition relative to the frame. The hoisting mechanism includes a fluid actuator pivotally coupled to the frame and the dump body and actuatable to move the dump body with respect to the frame. Further, the hoisting mechanism includes a valve to facilitate a selective fluid flow with respect to a first chamber and a second chamber of the fluid actuator to actuate the fluid actuator and a pump to provide a supply of the fluid flow to the valve. The hoisting mechanism also includes a system for controlling the hoisting mechanism of the hauling machine. The system includes an input device and a controller. The input device is configured to be moved to a desired input location of a plurality of input locations to generate a request. Corresponding requests may be generated when the input device moves to the plurality of input locations. The controller is configured to receive the request to vary the dump body between the rest condition and the raised condition; determine a criteria for actuating the hoisting mechanism corresponding to the request, the criteria including an actuation direction and an actuation speed for the fluid actuator; move the valve to a predefined position based on the actuation direction to set a direction of movement of the dump body between the rest condition and the raised condition; and control each of a state of the valve in the predefined position of the valve and an operational speed of the pump based on the actuation speed to set a rate of movement of the dump body along the direction of movement.

### BRIEF DESCRIPTION OF THE DRAWINGS

FIG. 1 is a side view of a dump truck having a dump body and a hoisting mechanism enabling the dump body to be in a rest condition with respect to a frame of the dump truck, in accordance with an embodiment of the present disclosure;

FIG. 2 is another side view of the dump truck in which the hoisting mechanism enables the dump body to be in a raised condition with respect to the frame, in accordance with an embodiment of the present disclosure;

FIG. 3 is a schematic view of the hoisting mechanism and a system for controlling the hoisting mechanism in which an input device of said system is in a first input location and a valve of the hoisting mechanism is in a first valve position, in accordance with an embodiment of the present disclosure;

FIG. 4 is a schematic view of the hoisting mechanism and the system in which the input device is in a second input location and the valve is in a second valve position, in accordance with an embodiment of the present disclosure;

FIG. 5 is a schematic view of the hoisting mechanism and the system in which the input device is in a third input location and the valve is in a third valve position, in accordance with an embodiment of the present disclosure;

FIG. 6 is a schematic view of the hoisting mechanism and the system in which the input device is in a fourth input location and the valve is in a fourth valve position, in accordance with an embodiment of the present disclosure; and

FIGS. 7 through 9 are graphs exemplarily and correspondingly illustrating variations in a state of the valve and in a speed of a pump of the hoisting mechanism as the input device varies between the input locations illustrated in FIGS. 3 through 6, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

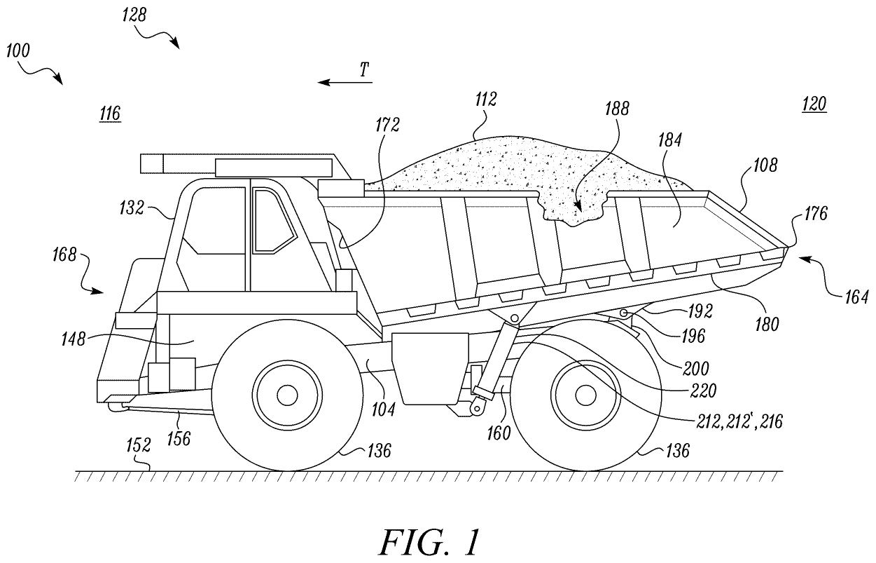

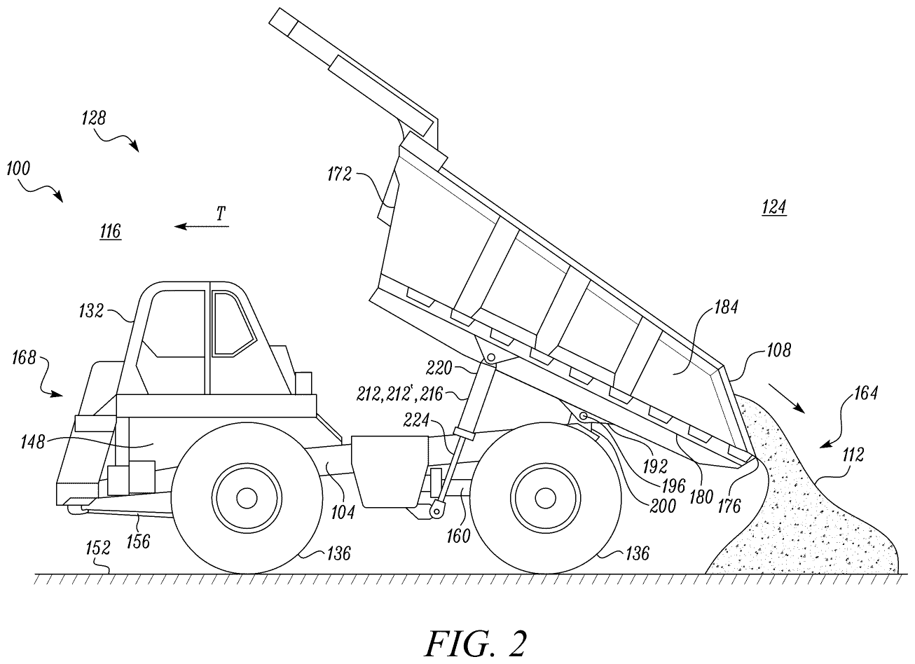

Referring to FIGS. 1 and 2, an exemplary hauling machine 100 is shown. The hauling machine 100 may include a frame 104 and a dump body 108 within which a payload 112 (e.g., a material, such as ores, minerals, and/or the like) may be received. The hauling machine 100 may be used for transferring or hauling the payload 112 from one location to another location at a worksite 116. Locations of the worksite 116 between which the hauling machine 100 may traverse back and forth may include load locations (see load location 120 in FIG. 1) from where the hauling machine 100 (e.g., the dump body 108 of the hauling machine 100) may receive the material into the dump body 108 as payload 112, and dump locations (see dump location 124 in FIG. 2) up to where the hauling machine 100 may travel to so as to dump or release the payload 112. Examples of the worksite 116 may include, but are not limited to, a construction site, a mine site, a landfill, a quarry, an underground mine site, and the like.

Although not limited, the hauling machine 100 may include an off-highway truck or a large mining truck 128. Aspects of the present disclosure may be applied to other machines having dump bodies, as well. For example, the hauling machine 100 may include or may be representative of any mobile machine or a construction machine having a movable dump body or a truck bed. In this regard, the hauling machine 100 can also correspond to an articulated dump truck and/or a pick-up truck. Therefore, reference to off-highway trucks or large mining trucks, as noted above, is exemplary.

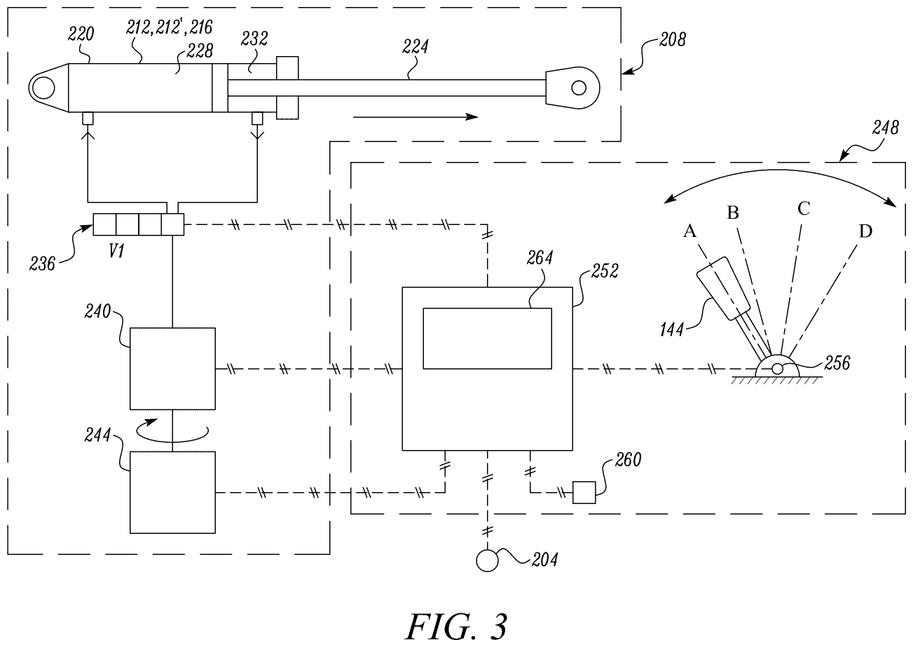

The hauling machine 100 may further include an operator cab 132 and one or more traction devices 136. The operator cab 132 may house various parts and systems, such as control panels, input devices, etc., of the hauling machine 100. The operator cab 132 may also be applied to accommodate/station one or more operators (not shown) of the hauling machine 100 such that the operators may access the input devices and/or the control panels to control the many functions of the hauling machine 100. As an example, the traction devices 136 may be controlled by accessing one or more input devices or control panels of the operator cab 132 and said control may help to actuate the traction devices 136 and move the hauling machine 100 at the worksite 116. The dump body 108 may also be controlled by accessing one or more input devices (e.g., see input device 144 in FIGS. 3 through 6) or control panels of the operator cab 132, as will be described further below.

The hauling machine 100 may also include several other parts and/or sub-systems, such as a power compartment 148 that may house a power source (e.g., an electrical power source such as a battery, a diesel run power source, a fuel cell based power source, or any other power source, now known or in the future developed) (not shown) usable for powering various functions of the hauling machine 100. The functions of the hauling machine 100 may include, but are not limited to, propelling the hauling machine 100 over a ground surface 152 of the worksite 116, manipulating one or more implements or devices (e.g., the dump body 108) of the hauling machine 100, and the like, for performing any useful work such as the transfer of the payload 112. For convenience, the hauling machine 100 may be simply hereinafter referred to as a ‘machine 100’, hereinafter.

The frame 104 may include a rigid structure to which nearly every other component (and/or sub-component) of the machine 100 may be coupled to. As an example, a forward portion 156 of the frame 104 may support the operator cab 132, while a rearward portion 160 of the frame 104 may support the dump body 108. Apart from the operator cab 132, the forward portion 156 may also support the power compartment 148 housing the power source. The rearward portion 160 and/or the dump body 108 may define a rearward end 164 of the machine 100. Likewise, the forward portion 156 and/or the operator cab 132 may define a forward end 168 of the machine 100. Although not limited, the frame 104 may include, at least in part, a configuration similar to that of a ladder frame layout. In case of articulated dump trucks, the frame 104 may include a split frame configuration exemplarily having a forward frame segment and a rearward frame segment hinged to each other.

The dump body 108 may define a front end 172 (to face the operator cab 132) and a rear end 176 (to face rearwardly of the machine 100). Further, the dump body 108 may include a floor (not shown) and an underbody 180 defined under the floor. Also, the dump body 108 may include a number of sidewalls—e.g., see a sidewall 184. A similar sidewall may be present at an opposite side of the machine 100, but which is not visible in the orientation of the machine 100 in FIGS. 1 and 2. As an example, the sidewalls (e.g., see sidewall 184) may extend upright with respect to the floor, and together with the floor, may define a cavity 188 of the dump body 108 into which payload 112 may be received for material transfer, during operations.

Further, the dump body 108 may be pivotably coupled to the frame 104 (e.g., to the rearward portion 160 of the frame 104). As an example, the dump body 108 may include an arrangement of a bracket 192 and a pin 196 as shown in the orientation of the machine in FIGS. 1 and 2. The pin 196 may pass through the bracket 192 and an engagement structure 200 formed on the rearward portion 160 of the frame 104 to pivotably couple the dump body 108 with the frame 104. Such an arrangement may be disposed towards the rearward end 164 of the dump body 108, as shown. A similar arrangement of a bracket and a pin may be provided at the other side of the machine 100 as well, but which cannot be viewed in the orientation of the machine in FIGS. 1 and 2.

By way of such exemplary arrangements, a pivotable coupling between the dump body 108 and the frame 104 may be enabled. Such pivotable coupling between the dump body 108 and the frame 104 may enable the dump body 108 to be moved between a rest condition (see FIG. 1) and a raised condition (see FIG. 2) relative to the frame 104. The rest condition may correspond to a condition in which the dump body 108 may be seated or resting on or atop the rearward portion 160 of the frame 104. The raised condition may correspond to a condition in which the dump body 108 is unseated and moved away from the rest condition and is conversely pivoted or tilted away with respect to the frame 104, about the pin 196.

During a movement of the machine 100 across the worksite 116, the dump body 108 may acquire or be in the rest condition with respect to the frame 104. When the machine 100 releases and/or dumps the payload 112 at the dump location 124, the dump body 108 may acquire or be in the raised condition with respect to the frame 104 such that the payload 112 received within the cavity 188 of the dump body 108 may flow out and be released from the dump body 108, e.g., under the action of gravity. In the rest condition of the dump body 108, as may be viewed from the orientation of the machine 100 in FIG. 1, the dump body 108 may be supported on the rearward portion 160 of the frame 104 such that the front end 172 of the dump body 108 may be directed towards the operator cab 132.

Conversely, in the raised condition of the dump body 108, as may be viewed from the orientation of the machine 100 in FIG. 2, the dump body 108 may be still supported on the rearward portion 160 of the frame 104, but in a manner that the rear end 176 may be directed towards the ground surface 152 while the front end 172 may be directed upwards and away from the ground surface 152. In some embodiments, the dump body 108 may include a dump body sensor 204 (e.g., see FIGS. 3 through 6) that may be configured to detect a position of the dump body 108 with respect to the frame 104, at any given point. A type and specification of such a sensor may be contemplated by someone in the art and will not be discussed further.

It may be noted that the terms ‘forward’ and ‘rearward’, and similar terms, as have been used herein, are in relation to an exemplary direction of travel of the machine 100, as represented by arrow, T, in FIG. 1, in which the machine 100 may generally travel so as to move or shuttle between the load location 120 and the dump location 124. Said direction of travel, T, is exemplarily defined from the rearward end 164 towards the forward end 168.

The traction devices 136 may be operably coupled to the frame 104 and may movably support the frame 104 (e.g., the forward portion 156 and the rearward portion 160) above the ground surface 152 to facilitate the movement of the machine 100 over the ground surface 152. For example, the traction devices 136 may be configured to receive power from the power source for propelling the frame 104 (and thus the machine 100) over the ground surface 152, thereby facilitating the machine's travel or movement along direction, T, through and across the expanse of the worksite 116. The traction devices 136 may include wheels, although other types of traction devices, such as endless tracks or crawler tracks, may be contemplated for employment either alone or in combination with the wheels. The traction devices 136 may include a pair of forward wheels and a pair of rearward wheels, as shown.

Referring to FIGS. 3 through 6, one or more aspects of the present disclosure corresponds to a hoisting mechanism 208 for the dump body 108. The hoisting mechanism 208 may be applied for moving the dump body 108 between the rest condition and the raised condition relative to the frame 104. The hoisting mechanism 208 may include one or more actuators 212 that may help effectuate the tilt of the dump body 108 with respect to the frame 104 and thus may help the dump body 108 attain (e.g., controllably attain) each of the rest condition and the raised condition with respect to the frame 104, and/or any intermediate condition therebetween.

As an example, the actuators 212 may correspond to a first actuator 212′ and a second actuator—the second actuator is hidden behind one or more portions of the machine, e.g., the first actuator 212′, and is thus not visible in the orientation of the machine 100 as provided in FIGS. 1 and 2. The second actuator may be similar in structure and function to the first actuator 212′. The forthcoming description mostly includes references to the first actuator 212′. A working of the second actuator may be similar to a working of the first actuator 212′, and therefore, discussions corresponding to the first actuator 212′ may be suitably applicable to the second actuator, as well. For convenience, the first actuator 212 may be simply referred to as an ‘actuator 212′’.

The actuator 212′ may be pivotally coupled between the rearward portion 160 of the frame 104 and the underbody 180 of the dump body 108, as shown in FIGS. 1 and 2. In other words, the actuator 212′ may be pivotally coupled to the frame 104 and the dump body 108 and may be actuatable to move the dump body 108 with respect to the frame 104. For example, the actuator 212 may be moved between an extended state and a retracted state to correspondingly move the dump body 108 between the raised condition and the rest condition. In one example, the actuator 212′ may include a fluid actuator 216 having a cylinder 220 and a rod 224 extendable (and retractable) relative to the cylinder 220. The fluid actuator 216 may define a first chamber 228 (or a head end chamber) and a second chamber 232 (or a rod end chamber). In one working scenario, e.g., to raise the dump body 108 with respect to the frame 104, the first chamber 228 may be suitably pressurized by an introduction of a fluid therein, e.g., from a fluid source such that the rod 224 extends with respect to the cylinder 220 and the actuator 212′ moves to the extended state. Simultaneously, fluid may be released from the second chamber 232. In another working scenario, e.g., to lower the dump body 108 with respect to the frame 104, the second chamber 232 may be suitably pressurized by an introduction of the fluid therein, e.g., from a suitable fluid source (such as the aforesaid fluid source itself) such that the rod 224 retract with respect to the cylinder 220 and the actuator 212′ moves to the retracted state. Simultaneously, fluid may be released from the first chamber 228.

When the fluid actuator 216 moves to the extended state, the fluid actuator 216 may cause the dump body 108 to pivot with respect to the frame 104, in turn angularly pushing (e.g., about the pin 196) and moving the dump body 108 upwards to the raised condition. In the raised condition, the front end 172 may face upwards and away from the ground surface 152 and the rear end 176 may face downwards and towards the ground surface 152. When the fluid actuator 216 moves to the retracted state, the fluid actuator 216 may cause the rear end 176 to pivot (e.g., about the pin 196 oppositely to the angular upward movement) with respect to the frame 104, in turn moving the dump body 108 to the rest condition such that the front end 172 may return to be directed towards the operator cab 132 and the rear end 176 may return to be directed rearwardly to the machine 100.

Apart from the actuator 212, the hoisting mechanism 208 may include a valve 236 and a pump 240, as well, as shown. The pump 240 may be run or powered by a motor 244 (e.g., an electric motor) and may be configured to provide a supply (e.g., a pressurized supply) of the fluid (e.g., from a tank or a reservoir) (not shown) to the valve 236. In some embodiments, the pump 240 may be powered by one or more other power sources, for example, an internal combustion engine, and/or by any other power source, now known or in the future developed. In the case of the internal combustion engine, a speed of the internal combustion engine may be varied to vary the speed of the pump 240. The valve 236 may be in turn used to regulate a fluid flow, received from the pump 240, to the chambers (first chamber 228 and second chamber 232) of the actuator 212. As an example, the pump 240 may be variable displacement pump, and, for example, may include a swashplate (not shown) to alter an inflow and/or an outflow of the fluid with respect to the pump 240. Optionally, or additionally, the inflow and/or the outflow of the fluid may be varied by controlling an output speed of the motor 244, as well.

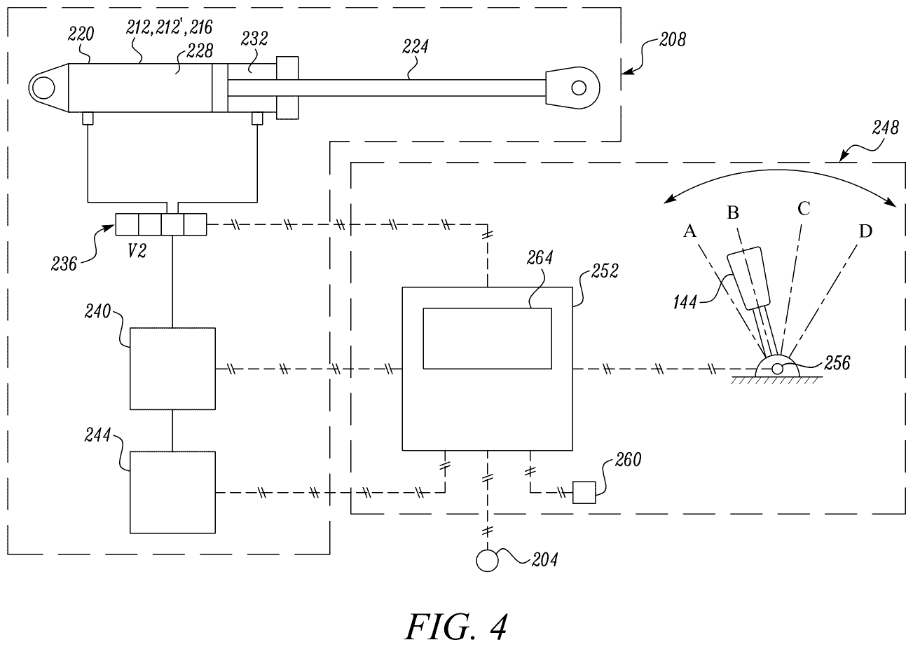

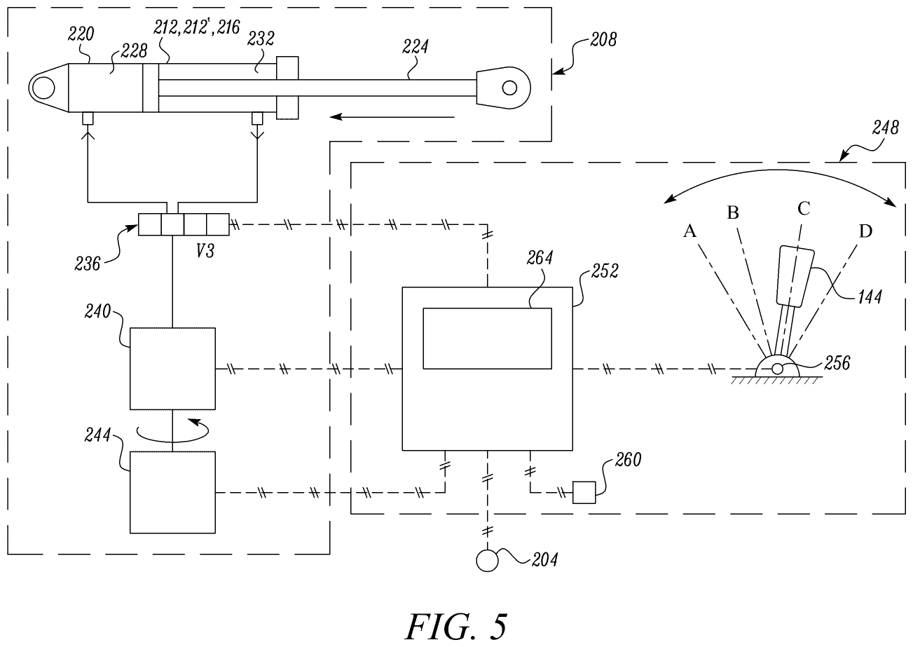

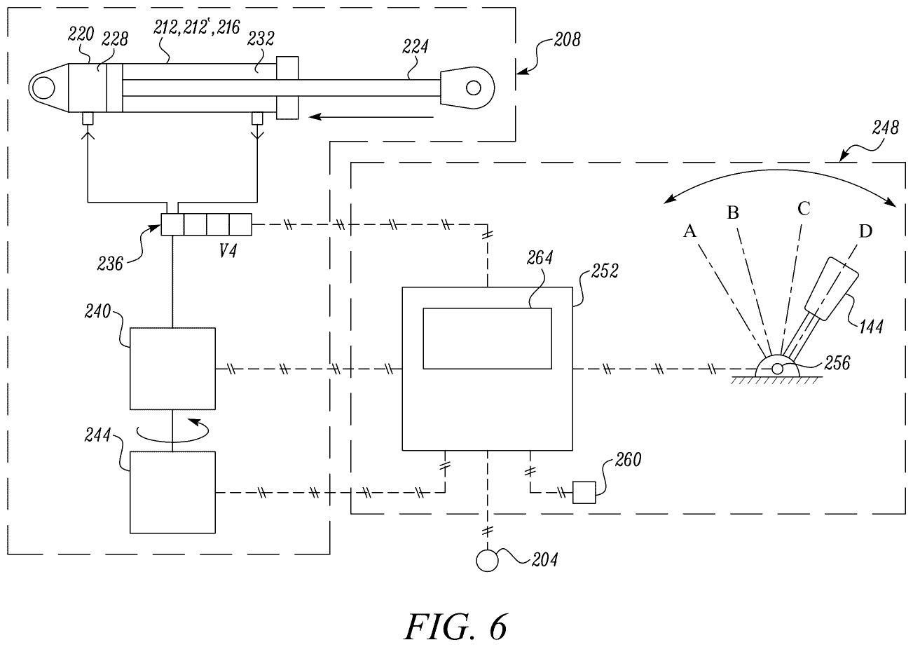

The valve 236 may receive the fluid supply from the pump 240 and may facilitate a selective fluid flow with respect to the first chamber 228 of the fluid actuator 216 and the second chamber 232 of the fluid actuator 216 to actuate the fluid actuator 216. The valve 236 may be a multi-position valve (e.g., a four position valve) configured to selectively control or regulate the flow of fluid to and from the first chamber 228 and the second chamber 232 of the fluid actuator 216, e.g., in one or more of its positions. In this regard, the valve 236 may be shifted between four (4) discrete valve positions during operations. The positions may include: a first valve position, V1, (see FIG. 3), a second valve position, V2, (see FIG. 4), a third valve position, V3, (see FIG. 5), and a fourth valve position, V4, (see FIG. 6). In some embodiments, the valve 236 may be moved to the first valve position, V1, the second valve position, V2, the third valve position, V3, and the fourth valve position, V4, to selectively and correspondingly enable ‘lower’, ‘hold’, ‘float’, and ‘raise’ functions, of the dump body 108, with respect to the frame 104 of the machine 100. In some embodiments, the valve 236 may be shifted between a different number of discrete valve positions, e.g., three (3) discrete valve positions, and, therefore, the four (4) discrete valve positions discussed above are exemplary.

The ‘lower’ function of the dump body 108 may correspond to a powered lowering of the dump body 108 with respect to the frame 104 to attain the rest condition of the dump body 108; the ‘float’ function of the dump body 108 may correspond to a lowering of the dump body 108 with respect to the frame 104 under the action of gravity to attain the rest condition of the dump body 108; the ‘hold’ function of the dump body 108 may correspond to restraining or locking a movement of the dump body 108 at any condition (or angular position) between the rest condition and the raised condition with respect to the frame 104; and the ‘raise’ function of the dump body 108 may correspond to a powered raising of the dump body 108 with respect to the frame 104 to attain the raised condition of the dump body 108.

In some embodiments, the valve 236 may provide for variations in one or more of its valve positions, e.g., the first valve position, V1, the second valve position, V2, and the fourth valve position, V4, such that fluid flow through the valve 236 may be regulated, and accordingly the movement of the dump body 108 (e.g., a rate of movement of the dump body 108) may be controlled during each of the lower, float, and raise functions, of the dump body 108. To achieve such variation in valve position and/or regulation in the fluid flow, the valve 236, for example, may include a directional control valve, e.g., a proportional directional control valve, which may include a spool (not shown) that can be varied (e.g., by way of an electronic control unit or ECU) to meet to a duty cycle, as desired, in order to achieve the variation in valve position, and thus, the regulation of the fluid flow, as discussed above.

It will be appreciated that variations in the valve positions and/or regulation in the fluid flow may correspond to changes to a state of the valve 236. It may be noted that the regulation of the fluid flow by the valve 236 may be maximum at each of the discrete valve positions—i.e., the first valve position, V1, (e.g., to lower the dump body 108 with a maximum fluid force), the second valve position, V2, (e.g., to lower the dump body 108 with a maximum fluid discharge under the action of gravity), and the fourth valve position, V4, (e.g., to raise the dump body 108 with a maximum fluid force).

With regard to the hold function, no fluid flow regulation may be provided by the valve 236 during the hold function. The hold function may be enacted by bringing the valve 236 to the third valve position, V3, (and thus the hold function may correspond to the third valve position, V3 of the valve 236) and in which the valve 236 may be closed (e.g., totally closed) for any fluid flow to be regulated therethrough. In other words, in the third valve position of the valve 236, the fluid flow with respect to the first chamber 228 and second chamber 232 of the actuator 212 may be altogether arrested and/or stopped by the valve 236. A structure and a manner of functioning of such a valve (i.e., the valve 236) is well known to those of skill in the art, and, thus, will not be discussed further.

With continued reference to FIGS. 3 through 6, according to an aspect of the present disclosure, the machine 100 may include a system 248 for controlling the hoisting mechanism 208 for moving the dump body 108 between the rest condition and the raised condition relative to the frame 104. The system 248 may include the input device 144 and a controller 252. The input device 144 may be manipulatable between various locations. Although not limited, the input device 144 may be provided within the operator cab 132 such that the input device 144 can remain accessible to one or more operators of the machine 100. In some embodiments, however, the input device 144 (and/or one or more control panels for the machine 100) may be situated remotely to the operator cab 132 and to the machine 100, e.g., at a remote site such that the machine 100 may be controlled from the remote site.

The input device 144 may be used or manipulated to move or articulate the dump body 108 (e.g., move the dump body 108 between the rest condition and the raised condition) relative to the frame 104. According to an example embodiment of the present disclosure, to articulate the dump body 108, the input device 144 may be moved between multiple input locations. More particularly, the input device 144 may be moved to four (4) discrete input locations, e.g., a first input location, A, (see FIG. 3), a second input location, B, (see FIG. 4), a third input location, C, (see FIG. 5), and a fourth input location, D, (see FIG. 6). As an example, when the input device 144 is moved to the discrete locations, e.g., the first input location, A, the second input location, B, the third input location, C, and the fourth input location, D, the valve 236 may be correspondingly shifted to the four (4) discrete valve positions, e.g., the first valve position, V1, the second valve position, V2, the third valve position, V3, and the fourth valve position, V4, such that the dump body 108 can be articulated in a desired manner. In some embodiments, the input device 144 may be moved to a different number of discrete locations, e.g., three (3) discrete locations, and, therefore, the four (4) discrete input locations is exemplary. Although not limited, the number of locations that the input device 144 may be moved to may equal and/or correspond to the number of discrete positions the valve 236 may be shifted to.

Also, the input device 144 may be moved to multiple intermediate input locations defined between at least two (or more) discrete input locations of the at least four (4) discrete input locations. As an example, the input device 144 may be movable, at any given point, to intermediate input locations, e.g., between the first input location, A, and the second input location, B, between the second input location, B, and the third input location, C, and between the third input location, C, and the fourth input location, D, so as to be varied between those locations. When the input device 144 may acquire an intermediate location between two discrete locations, e.g., the third location and the fourth location, a corresponding variation in a position of the valve 236 and a corresponding manner of operation of the pump 240 may be attained. In effect, by way of the movement of the input device 144 to the discrete input locations and to the intermediate input locations, a movement of the dump body 108 with respect to the frame 104 may be more precisely controlled and/or regulated.

In further detail, the input device 144 may correspond to a lever and/or a joystick, as shown, which during use, may be exemplarily manipulated and/or moved in a back and forth manner to provide input, e.g., in the form of a ‘request’. The back and forth movement may cause the input device 144 to sweep through an exemplary angular displacement (such as along a plane) from a first angle (see location of the input device 144 in FIG. 3) to a second angle (see location of the input device 144 in FIG. 6). As an example, the first input location, A, of the input device 144 may correspond to the first angle of the input device 144, and the fourth input location, D, of the input device 144 may correspond to the second angle of the input device 144. The second input location, B, and the third input location, C, may be exemplary locations defined along the travel of the input device 144 between the first angle and the second angle.

In some embodiments, the input device 144 may work in conjunction with an input device sensor 256 which may be applied to detect a location (among the many discrete and/or intermediate locations) that the input device 144 may be in, at any given point. In some embodiments, a signal generated by the input device sensor 256, indicating any location of the input device 144, may form, at least in part, the aforementioned ‘request’. Effectively, a corresponding request may be generated at least at each of the input locations of the many input locations defined between the first input location, A, and the fourth input location, D, or between the first angle and the second angle. For the purposes of the present disclosure, a request generated at any of the discrete input locations may be referred to as a ‘discrete request’ and a request generated at any of the intermediate input locations may be referred to as an ‘intermediate request’. A type and specification of such a sensor may be well contemplated and applied by someone in the art and will not be discussed further.

The controller 252 may be communicatively coupled to the input device 144. The controller 252 may also be communicatively and operatively coupled with the actuator 212′, the valve 236, and the pump 240 (e.g., optionally, or additionally, with the motor 244 associated with the pump 240), so as to actuate each of these. As an exemplary process, the controller 252 may be configured to receive the request (e.g., the signal) from the input device 144 or from the input device sensor 256. The request may indicate a desired input location (e.g., as desired by an operator of the machine 100) that the input device 144 may be in or moved to, which may be defined anywhere between the first angle (e.g., the first input location, A) and the second angle (e.g., the fourth input location, D). In response to the receipt of the signal, the controller 252 may be configured to retrieve (e.g., from a memory 260) a set of instructions to run the set of instructions (e.g., by way of a processor 264 that may be integrated within the controller 252, or, alternatively, operatively coupled to the controller 252).

As part of running the set of instructions, the controller 252 may be configured to decipher a value associated with the request. As an example, the value may include an angular deviation or an angular position that the input device 144 may be in (e.g., with respect to a base or a horizontal or any reference axis), e.g., when the input device 144 is at the desired input location. It will be appreciated that corresponding requests may be generated as the input device 144 moves to each of the input locations defined between the first input location, A, and the fourth input location, D. Said corresponding requests may also include or correspond to corresponding values associated with the input locations, and each of which may be decipherable by the controller 252 by running the set of instructions.

Further, as part of running the set of instructions, the controller 252 may be configured to retrieve a map (e.g., from the memory 260). The map may include multiple values that correspond to the multiple input locations the input device 144 can move to (i.e., anywhere between the first input location, A, and the fourth input location, D). The map may further include multiple criteria for actuating the hoisting mechanism 208 corresponding to the request in correspondence to the multiple values. More particularly, each criteria may include a corresponding actuation direction (or a requested actuation direction) and a corresponding actuation speed (or a requested actuation speed) for the actuator 212″.

In the case of the selection (e.g., by an operator of the machine 100) of the desired input location, the controller 252 may detect the deciphered value corresponding to the desired input location in the map and then corelate the deciphered value (e.g., referred to as desired value) with a corresponding criteria from the map. The corresponding criteria (e.g., a desired criteria and/or the requested criteria) may include a corresponding actuation direction (e.g., a desired actuation direction and/or the requested actuation direction) and a corresponding actuation speed (e.g., a desired actuation speed and/or the requested actuation speed) for the actuator 212′.

Once the desired actuation direction and the desired actuation speed is determined by using the map, the controller 252 may move the valve 236 to a predefined position (e.g., any of the valve positions described above) based on the desired actuation direction to set a direction of movement of the dump body 108 between the rest condition and the raised condition. To move the valve 236 to the predefined position, the controller 252 may be configured to shift the valve 236 to one of the four (4) discrete valve positions including: the first valve position, V1, the second valve position, V2, the third valve position, V3, and the fourth valve position, V4, (i.e., when the input device 144 is correspondingly moved to the first input location, A, the second input location, B, the third input location, C, and the fourth input location, D). Further, the controller 252 may control each of a state of the valve 236 in the predefined position of the valve 236 (e.g., to vary the valve in the predefined position). Moreover, the controller 252 may also control an operational speed of the pump 240 (e.g., by controlling the motor 244 and/or by controlling the swashplate that may be associated with the pump 240) based on the desired actuation speed to set a rate of movement of the dump body 108 along the direction of movement.

It will be appreciated that the controller 252 may be configured to control the state of the valve 236 in any of the valve positions in which the valve 236 is shifted to. In effect, to control the state of the valve 236 in the predefined position of the valve 236, the controller 252 may be configured to regulate the flow of fluid through the valve 236 in one of the first valve position, V1, the second valve position, V2, and the fourth valve position, V4, to which the valve 236 is shifted, correspondingly when the input device 144 moves or varies between the first input location, A, and the second input location, B, the second input location, B, and the third input location, C, and the third input location, C, and the fourth input location, D.

Further, the controller 252 is configured to stop the flow of fluid through the valve 236 in the third valve position, V3, to which the valve 236 may be shifted when the input device 144 moves to the third input location, C. This is because the third valve position, V3, corresponds to the hold function of the dump body 108 in which the dump body 108 is to be restrained or locked immovably at any position it may be in. Also, the terms ‘flow of fluid’ and ‘fluid flow’, as used in the present disclosure, may be interchangeable with each other. For ease of understanding, an exemplary manner in which the controller 252 may control the valve 236 and the pump 240 may be found in Table 1 below.

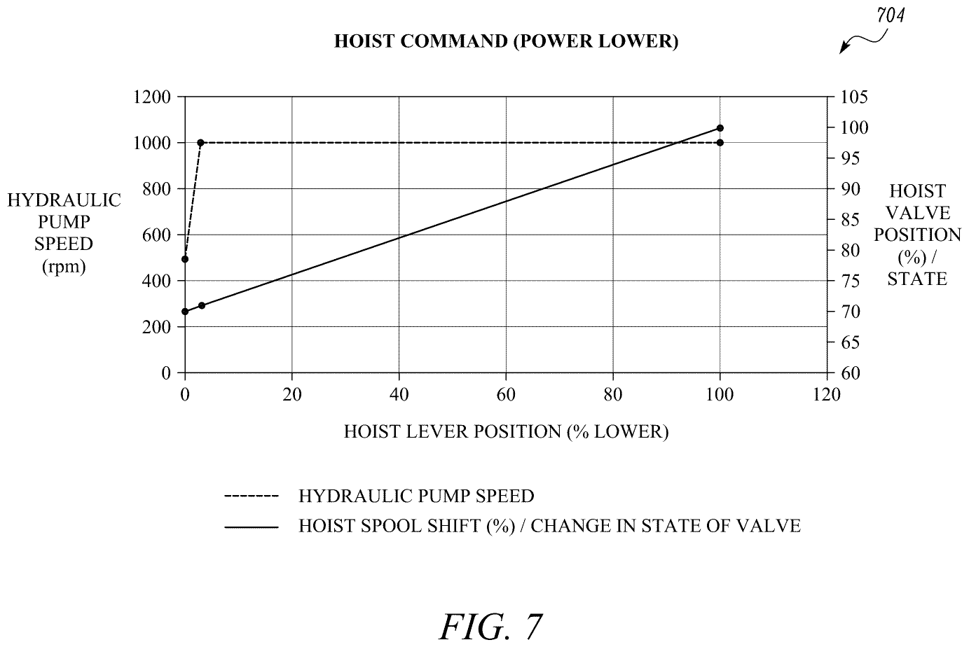

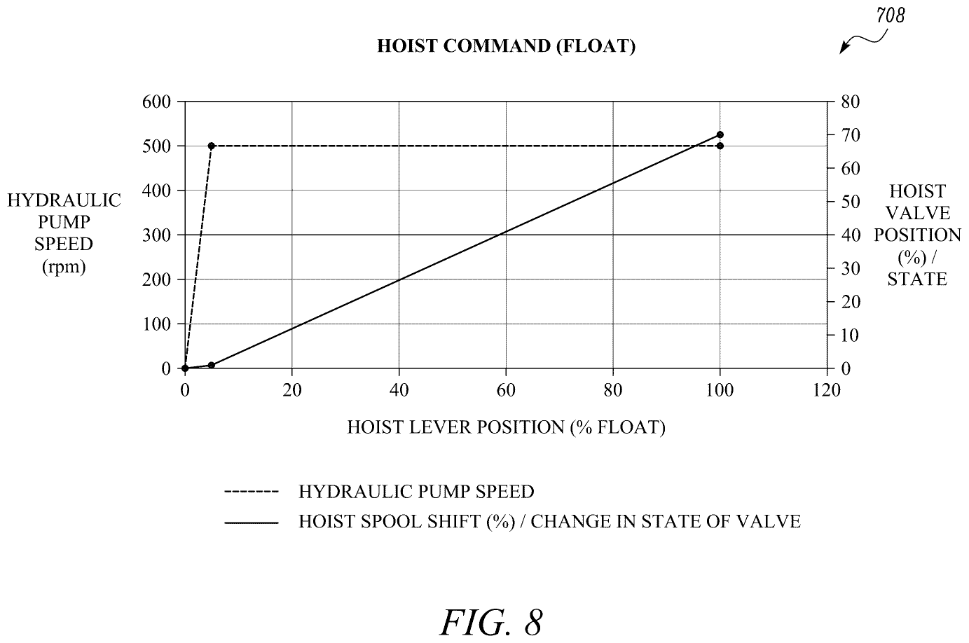

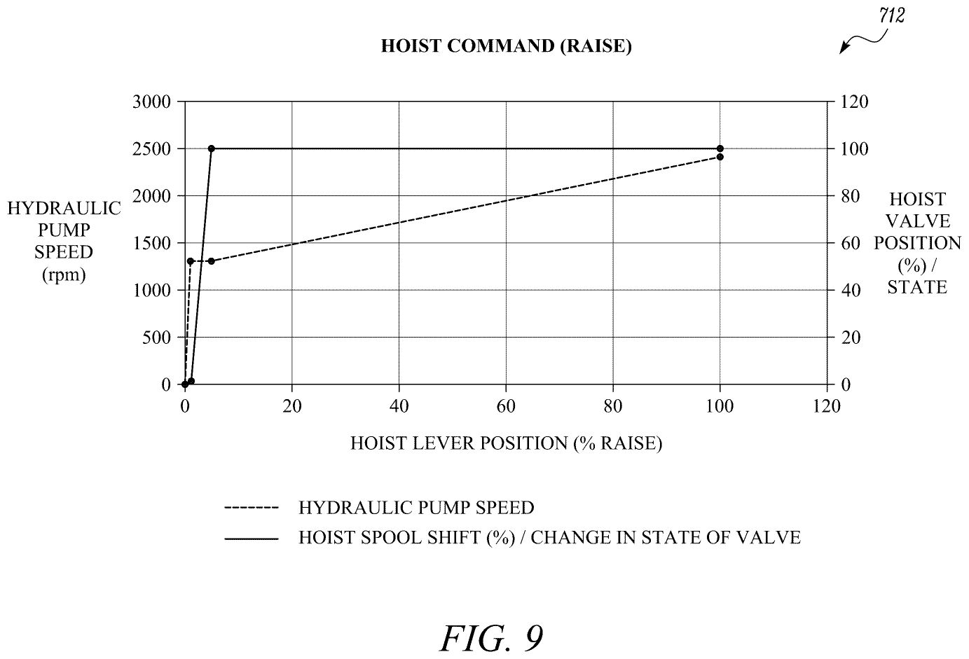

Such control may be understood in conjunction with the graphs that are exemplarily provided in FIGS. 7 through 9. For example, a first graph 704 in FIG. 7 illustrates an exemplary variation in the state of the valve 236 and in the speed of the pump 240 as the input device 144 varies between the first input location, A, and the second input location, B. A second graph 708 in FIG. 8 illustrates an exemplary variation in the state of the valve 236 and in the speed of the pump 240 as the input device 144 varies between the second input location, B, and the third input location, C. A third graph 712 in FIG. 9 illustrates an exemplary variation in the state of the valve 236 and in the speed of the pump 240 as the input device 144 varies between the third input location, C, and the fourth input location, D.

TABLE 1

| Function | Input Device Location | Valve Position and State | Pump Speed |
|---|---|---|---|
| Lower | Between the first input | At the first valve position, V1, | Fixed or set |
| | location, A, and the | and in a variable state based on | at a first |
| | second input location, B | the input device's location | value |
| | | between the first input location, | |
| | | A, and the second input location, B | |
| Float | Between the second | At the second valve position, | Fixed or set |
| | input location, B, and | V2, and in a variable state based | at a second |
| | the third input location, C | on the input device's location | value |
| | | between the second input | |
| | | location, B, and the third input | |
| | | location, C | |
| Hold | At the third input | At the third valve position, V3, | Set at zero |
| | location, C | and in a non-variable state | (0) |
| Raise | Between the third input | At the fourth valve position, V4, | Variable |
| | location, C, and the | and in a variable state based on | speed based |
| | fourth input location, D | the input device's location | on the input |
| | | between the third input location, | device's |
| | | C, and the fourth input location, D | location |

The controller 252 may be communicably coupled to the machine's main control module (not shown), such as a safety module or a dynamics module, or may be configured as a stand-alone entity. Optionally, the controller 252 may be integral to and be one and the same as the machine's main control module. Further, the controller 252 may include a microprocessor-based device, and/or may be envisioned as an application-specific integrated circuit, or other logic devices, which provide controller functionality, and such devices being known to those with ordinary skill in the art.

In one example, it is possible for the controller 252 to include or be representative of one or more controllers having separate or integrally configured processing units to process a variety of data (e.g., input or commands or signals), e.g., incoming from the input device 144, each of which may be slated for the performance of one or more functions of the machine 100, as have been described for the controller 252 in the present disclosure. In some embodiments, a transmission of data between the controller 252 and various other controllers and/or devices, such as the valve 236 (e.g., the ECU of the valve 236), the pump 240 (e.g., the motor 244 associated with the pump 240), other input/output devices of the machine 100, etc., may be facilitated wirelessly or through a standardized CAN bus protocol. The controller 252 may be optimally suited for accommodation within certain machine panels or portions from where the controller 252 may remain accessible for ease of use, service, calibration, repairs, and replacements.

In some embodiments, it is possible for the controller 252 (and/or one or more other controllers, either alone or in combination with the controller 252) to run the machine 100 autonomously. In such a case, the input device 144 may be omitted and the request may be auto generated based on, e.g., a predetermined machine setting and or the request may be deduced by machine modules (e.g., a machine learning module) that may enable the machine 100 to learn and adapt to varying requirements of a work cycle and/or a worksite in which the machine 100 operates. In so doing, that which is learnt and/or is auto generated may be applied to generate the ‘request’ for controlling or moving or positioning the dump body 108 (along with the hoisting mechanism 208) in a desired manner.

Processing units or the processor 264 associated with the controller 252, to convert and/or process various input, command, signals, and/or the like, may include, but are not limited to, an X86 processor, a Reduced Instruction Set Computing (RISC) processor, an Application Specific Integrated Circuit (ASIC) processor, a Complex Instruction Set Computing (CISC) processor, an Advanced RISC Machine (ARM) processor, or any other processor.

Examples of the memory 260 may include a hard disk drive (HDD), and a secure digital (SD) card. Further, the memory 260 may include non-volatile/volatile memory units such as a random-access memory (RAM)/a read only memory (ROM), which may include associated input and output buses. The memory 260 may be configured to store various other instruction sets for various other functions of the machine 100, along with the set of instruction, discussed above.

### INDUSTRIAL APPLICABILITY

An exemplary manner of operation of the system 248 is discussed below in reference to FIGS. 3 through 6. Said exemplary manner of operation is also discussed in conjunction with FIGS. 7 through 9. During an operational work cycle of the machine 100, an operator of the machine 100 may access and vary the input device 144 to bring the input device 144 to any desired input location. Assuming that the machine 100 may be at the dump location 124, the dump body 108 may be in the raised position (see FIG. 2) to release the payload 112 (e.g., a first payload) received within the dump body 108, e.g., under the action of gravity. Once the first payload is released, the operator may desire to move the dump body 108 to the rest condition and thus may lower the dump body 108 with respect to the frame 104 of the machine 100. Therefore, in one exemplary implementation (e.g., a first implementation), the desired input location of the input device 144 may be the first input location, A, (see FIG. 3) for enabling the ‘lower’ function such that the dump body 108 can be returned or lowered to the rest condition from the raised condition.

As the input device 144 moves to the first input location, A, the controller 252 may shift the valve 236 to the predefined position (e.g., the first valve position, V1). In the first valve position, V1, the fluid flow may drain out from the first chamber 228 of the fluid actuator 216 and may enter the second chamber 232 of the fluid actuator 216 for powering the lowering of the dump body 108 relative to the frame 104. While a power or force applied to lower the dump body 108 may be maximum in the first valve position, V1, of the valve 236 (e.g., when generating a discrete request), if it were needed to modulate (e.g., reduce) said power or force, the operator may move or vary the input device 144 between the first input location, A, and the second input location, B, in order to regulate the aforesaid fluid flow. For example, at any location of the input device 144 between the first input location, A, and the second input location, B, (e.g., when generating an intermediate request), the controller 252 controls the state of the valve 236 in the first valve position, V1, such that a regulation of the fluid flow through the valve 236 corresponds (e.g., proportionally) to the input location of the input device 144 between the first input location, A, and the second input location, B.

Further, with the input device 144 being in the same input location as in the above described first implementation, e.g., between the first input location, A, and the second input location, B, the controller 252 may also control the operational speed of the pump 240 by setting the operational speed of the pump 240 at a first value (e.g., a fixed first value for throughout the movement of the input device 144 between the first input location, A, and the second input location, B) so as to power the lowering of the dump body 108 to the rest condition. As an example, the first value may be 1000 rotations per minute (RPM), although these values can change in actual practice and/or application of the system 248, and thus they have been provided for illustrative purposes alone.

In another exemplary implementation (e.g., a second implementation), and for lowering the dump body 108 of the machine 100, the desired input location of the input device 144 may be the second input location, B, for enabling the ‘float’ function such that the dump body 108 can be returned and/or lowered to the rest condition from the raised condition, e.g., owing to the weight of the dump body 108, under the action of gravity. In some embodiments, the input device 144 may be assisted with a spring return mechanism or a biasing mechanism (not shown) that helps the input device 144 return automatically to the second input location, B, from the first input location, A, or from anywhere between the first input location, A, and the second input location, B.

As the input device 144 moves to the second input location, B, the controller 252 may shift the valve 236 to the predefined position (e.g., the second valve position, V2). In the second valve position, V2, the fluid flow may drain out from the first chamber 228 of the fluid actuator 216 and may enter the second chamber 232 of the fluid actuator 216 to lower the dump body 108 relative to the frame 104, e.g., under the action of gravity. While a power or force (e.g., gravitational force owing to at least a weight of the dump body 108) applied to lower the dump body 108 to facilitate fluid discharge through the valve 236 may be maximum based on the position of the valve 236 in the second valve position, V2, (e.g., when generating a discrete request) if it were needed to modulate (e.g., reduce) said power or force, the operator may move or vary the input device 144 between the second input location, B, and the third input location, C, in order to regulate the aforesaid fluid flow. For example, at any location of the input device 144 between the second input location, B, and the third input location, C, (e.g., when generating an intermediate request), the controller 252 may control the state of the valve 236 in the second valve position, V2, such that a regulation of the fluid flow through the valve 236 corresponds (e.g., proportionally) to the input location of the input device 144 between the second input location, B, and the third input location, C.

Further, with the input device 144 being in the same input location as in the above described second implementation, e.g., between the second input location, B, and the third input location, C, the controller 252 may also control the operational speed of the pump 240 by setting the operational speed of the pump 240 at a second value (e.g., a fixed second value for throughout the movement of the input device 144 between the second input location, B, and the third input location, C) for lowering the dump body 108 under an action of gravity to the rest condition. As an example, the second value may be 500 RPM, although these values can change in actual practice and/or application of the system 248, and thus they have been provided for illustrative purposes alone. Although not limited, the second value may be lower than the first value.

Once the dump body 108 is lowered (e.g., fully lowered) to the rest condition, the operator may access other controls of the machine 100 to move the machine 100 from the dump location 124 to the load location 120 so as to receive more payload (e.g., a second payload) into the cavity 188 of the dump body 108. This allows for additional material transfer. Once the second payload is received into the cavity 188, the operator may move the machine 100 and return to the dump location 124 to deposit the second payload at the dump location 124. Having returned to the dump location 124, the operator may need to dump the second payload at the dump location 124. Therefore, in yet another exemplary implementation (e.g., a fourth implementation) (a third implementation is discussed with respect to the third input location, C, of the input device below), the desired input location of the input device 144 may be the fourth input location, D, (see FIG. 6) for enabling the ‘raise’ function such that the dump body 108 can be raised to the raised condition.

As the input device 144 moves to the fourth input location, D, the controller 252 may shift the valve 236 to the predefined position (e.g., the fourth valve position, V4). In the fourth valve position, V4, the fluid flow may drain out from the second chamber 232 of the fluid actuator 216 and may enter the first chamber 228 of the fluid actuator 216 for powering a raising of the dump body 108 relative to the frame 104. While a power or force applied to raise the dump body 108 may be maximum in the fourth valve position, V4, of the valve 236 (e.g., when generating a discrete request), if it were needed to modulate (e.g., reduce) said power or force, the operator may move or vary the input device 144 between the third input location, C, and the fourth input location, D, in order to regulate the aforesaid fluid flow. For example, at any location of the input device 144 between the third input location, C, and the fourth input location, D, (e.g., when generating an intermediate request) the controller 252 may control the state of the valve 236 in the fourth valve position, V4, such that a regulation of the fluid flow through the valve 236 corresponds (e.g., proportionally) to the input location of the input device 144 between the third input location, C, and the fourth input location, D.

Further, with the input device 144 being in the same input location as in the above described fourth implementation, e.g., between the third input location, C, and the fourth input location, D, the controller 252 may control the operational speed of the pump 240 by causing the operational speed of the pump 240 to vary (e.g., proportionally vary) as the input device 144 varies between the third input location, C, and the fourth input location, D, for powering a raising of the dump body 108 to the raised condition. As an example, for a per unit variation of the input device 144 between the third input location, C, and the fourth input location, D, (e.g., during a movement from the third input location, C, towards the fourth input location, D), the controller 252 may vary (e.g., increase) on a per unit basis, the operational speed of the pump 240.

If at any point during raising or lowering the dump body 108, the dump body's movement were desired to be stopped and its position locked, the operator may move (or release) the input device 144 to the third input location, C. In the third implementation, therefore, for holding the dump body 108 of the machine 100, the desired input location of the input device 144 may be the third input location, C, for enabling the ‘hold’ function such that the dump body 108 can be held in place and stopped from movement at any condition between the rest condition and the raised condition. In some embodiments, the input device 144 may be assisted with a spring return mechanism or a biasing mechanism (not shown) that may help the input device 144 return automatically to the third input location, C, from the fourth input location, D, or from anywhere between the third input location, C, and the fourth input location, D.

As the input device 144 moves to the third input location, C, the controller 252 may shift the valve 236 to the predefined position (e.g., the third valve position, V3). In the third valve position, V3, the fluid flow may be shut or closed through the valve 236 such that the fluid flow with respect to the first chamber 228 of the fluid actuator 216 and the second chamber 232 of the fluid actuator 216 is stopped and there is no regulation of the fluid flow through the valve 236. Further, with the input device 144 being in the same input location as in the above described third implementation, e.g., at the third input location, C, the controller 252 may control the operational speed of the pump 240 by setting the operational speed of the pump 240 at a zero (0) value, e.g., by deactivating the pump 240. In that manner, fluid flow and regulation is stopped and the dump body 108 may be held in its place anywhere between the rest condition and the raised condition.

The system 248 enables a single input device (e.g., the input device 144) to alter both the valve 236 and the pump 240 for the control of the movement of the dump body 108 between the rest condition and the raised condition. Using a single input device allows an easier and a more optimized control, e.g., to an operator of the machine 100, for the movement of the dump body 108 between said raised conditions. Such control of the movement of the dump body 108 is particularly efficient in comparison to situations where the operator has to access more than one input devices, e.g., a lever along with a throttle, such as is found in conventional machines which may run on internal combustion engine. Although not limited, such single input devices may also be particularly applicable in electrically operated machines where a throttle and/or a gas pedal may be absent or omitted.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as examples only, with a true scope of the disclosure being indicated by the following claims and their equivalent.

What is claimed is:

1. A method for controlling a hoisting mechanism for a movement of a dump body between a rest condition and a raised condition relative to a frame, the method comprising:
receiving, by a controller, a request to vary the dump body between the rest condition and the raised condition;
determining, by the controller, a criteria for actuating the hoisting mechanism corresponding to the request, the criteria including an actuation direction and an actuation speed for a fluid actuator of the hoisting mechanism;
moving, by the controller, a valve, facilitating selective fluid flow with respect to a first chamber and a second chamber of the fluid actuator, to a predefined position based on the actuation direction to set a direction of movement of the dump body between the rest condition and the raised condition; and
controlling, by the controller, each of a state of the valve in the predefined position of the valve and an operational speed of a pump supplying the fluid flow to the valve based on the actuation speed to set a rate of movement of the dump body along the direction of movement.

2. The method of claim 1 further including using an input device configured to be moved between a plurality of input locations, wherein
the request is generated when the input device moves to a desired input location of the plurality of input locations, the request including a value associated with the desired input location; and
corresponding requests are generated when the input device moves to the plurality of input locations, the corresponding requests including corresponding values associated with the plurality of input locations.

3. The method of claim 2, wherein
the input device is configured to be moved to at least four (4) discrete input locations of the plurality of input locations and to multiple intermediate input locations of the plurality of input locations defined between at least two discrete input locations of the at least four (4) discrete input locations,
the four (4) discrete input locations includes a first input location, a second input location, a third input location, and a fourth input location, and
to move the valve to the predefined position, the method includes shifting, by the controller, the valve between four (4) discrete valve positions including: a first valve position, a second valve position, a third valve position, and a fourth valve position when the input device is correspondingly moved to the first input location, the second input location, the third input location, and the fourth input location.

4. The method of claim 3, wherein the valve is configured to be moved to the first valve position, the second valve position, the third valve position, and the fourth valve position, to selectively and correspondingly enable lower, hold, float, and raise functions, of the dump body with respect to the frame.

5. The method of claim 3, wherein controlling the state of the valve in the predefined position of the valve includes:
a regulation of a flow of fluid through the valve in one of the first valve position, the second valve position, and the fourth valve position, to which the valve is shifted, correspondingly when the input device moves or varies between the first input location and the second input location, the second input location and the third input location, and the third input location and the fourth input location, and
a stopping of the flow of fluid through the valve in the third valve position to which the valve is shifted when the input device moves to the third input location.

6. The method of claim 5, wherein when the input device moves between the first input location and the second input location:
the controller moves the valve to the predefined position by shifting the valve to the first valve position such that the fluid flow drains out from the first chamber of the fluid actuator and enters the second chamber of the fluid actuator for powering a lowering of the dump body relative to the frame,
the controller controls the state of the valve in the first valve position such that the regulation of the fluid flow through the valve corresponds to an input location of the input device between the first input location and the second input location, and
the controller controls the operational speed of the pump by setting the operational speed of the pump at a first value throughout the movement of the input device between the first input location and the second input location for powering a lowering of the dump body to the rest condition.

7. The method of claim 5, wherein when the input device moves between the second input location and the third input location:
the controller moves the valve to the predefined position by shifting the valve to the second valve position such that the fluid flow drains out from the first chamber of the fluid actuator and enters the second chamber of the fluid actuator to lower the dump body relative to the frame,
the controller controls the state of the valve in the second valve position such that the regulation of the fluid flow through the valve corresponds to an input location of the input device between the second input location and the third input location,
the controller controls the operational speed of the pump by setting the operational speed of the pump at a second value throughout the movement of the input device between the second input location and the third input location for lowering the dump body under an action of gravity to the rest condition, wherein
the second value is lower than a first value of the operational speed of the pump, the first value being applicable when the input device moves between the first input location and the second input location.

8. The method of claim 5, wherein when the input device moves between the third input location and the fourth input location:
the controller moves the valve to the predefined position by shifting the valve to the fourth valve position such that the fluid flow drains out from the second chamber of the fluid actuator and enters the first chamber of the fluid actuator for powering a raising of the dump body relative to the frame,
the controller controls the state of the valve in the fourth valve position such that the regulation of the fluid flow through the valve corresponds to an input location of the input device between the third input location and the fourth input location, and
the controller controls the operational speed of the pump by causing the operational speed of the pump to vary as the input device varies between the third input location and the fourth input location for powering a raising of the dump body to the raised condition.

9. The method of claim 5, wherein when the input device moves to the third input location:
the controller moves the valve to the predefined position by shifting the valve to the third valve position to shut the fluid flow through the valve such that the fluid flow with respect to the first chamber of the fluid actuator and the second chamber of the fluid actuator is stopped and there is no regulation of the fluid flow through the valve, and
the controller controls the operational speed of the pump by setting the operational speed of the pump at a zero (0) value.

10. A system for controlling a hoisting mechanism for a movement of a dump body between a rest condition and a raised condition relative to a frame, the system comprising:
an input device configured to be moved to a desired input location of a plurality of input locations to generate a request, wherein corresponding requests are generated when the input device moves to the plurality of input locations;
a controller configured to:
receive the request to vary the dump body between the rest condition and the raised condition;
determine a criteria for actuating the hoisting mechanism corresponding to the request, the criteria including an actuation direction and an actuation speed for a fluid actuator of the hoisting mechanism;
move a valve, facilitating selective fluid flow with respect to a first chamber and a second chamber of the fluid actuator, to a predefined position based on the actuation direction to set a direction of movement of the dump body between the rest condition and the raised condition; and
control each of a state of the valve in the predefined position of the valve and an operational speed of a pump supplying the fluid flow to the valve based on the actuation speed to set a rate of movement of the dump body along the direction of movement.

11. The system of claim 10, wherein
the input device is configured to be moved to at least four (4) discrete input locations of the plurality of input locations and to multiple intermediate input locations of the plurality of input locations defined between at least two discrete input locations of the at least four (4) discrete input locations,
the four (4) discrete input locations includes a first input location, a second input location, a third input location, and a fourth input location, and
to move the valve to the predefined position, the controller is configured to shift the valve between four (4) discrete valve positions including: a first valve position, a second valve position, a third valve position, and a fourth valve position when the input device is correspondingly moved to the first input location, the second input location, the third input location, and the fourth input location.

12. The system of claim 11, wherein the valve is configured to be moved to the first valve position, the second valve position, the third valve position, and the fourth valve position, to selectively and correspondingly enable lower, hold, float, and raise functions, of the dump body with respect to the frame.

13. The system of claim 11, wherein to control the state of the valve in the predefined position of the valve, the controller is configured to:
regulate a flow of fluid through the valve in one of the first valve position, the second valve position, and the fourth valve position, to which the valve is shifted, correspondingly when the input device moves or varies between the first input location and the second input location, the second input location and the third input location, and the third input location and the fourth input location, and
stop the flow of fluid through the valve in the third valve position to which the valve is shifted when the input device moves to the third input location.

14. The system of claim 13, wherein when the input device moves between the first input location and the second input location:
the controller moves the valve to the predefined position by shifting the valve to the first valve position such that the fluid flow drains out from the first chamber of the fluid actuator and enters the second chamber of the fluid actuator for powering a lowering of the dump body relative to the frame,
the controller controls the state of the valve in the first valve position such that a regulation of the fluid flow through the valve corresponds to an input location of the input device between the first input location and the second input location, and
the controller controls the operational speed of the pump by setting the operational speed of the pump at a first value throughout the movement of the input device between the first input location and the second input location for powering a lowering of the dump body to the rest condition.

15. The system of claim 13, wherein when the input device moves between the second input location and the third input location:
the controller moves the valve to the predefined position by shifting the valve to the second valve position such that the fluid flow drains out from the first chamber of the fluid actuator and enters the second chamber of the fluid actuator to lower the dump body relative to the frame,
the controller controls the state of the valve in the second valve position such that a regulation of the fluid flow through the valve corresponds to an input location of the input device between the second input location and the third input location,
the controller controls the operational speed of the pump by setting the operational speed of the pump at a second value throughout the movement of the input device between the second input location and the third input location for lowering the dump body under an action of gravity to the rest condition, wherein
the second value is lower than a first value of the operational speed of the pump, the first value being applicable when the input device moves between the first input location and the second input location.

16. The system of claim 13, wherein when the input device moves between the third input location and the fourth input location:
the controller moves the valve to the predefined position by shifting the valve to the fourth valve position such that the fluid flow drains out from the second chamber of the fluid actuator and enters the first chamber of the fluid actuator for powering a raising of the dump body relative to the frame,
the controller controls the state of the valve in the fourth valve position such that a regulation of the fluid flow through the valve corresponds to an input location of the input device between the third input location and the fourth input location, and
the controller controls the operational speed of the pump by causing the operational speed of the pump to vary as the input device varies between the third input location and the fourth input location for powering a raising of the dump body to the raised condition.

17. The system of claim 13, wherein when the input device moves to the third input location:
the controller moves the valve to the predefined position by shifting the valve to the third valve position to shut the fluid flow through the valve such that the fluid flow with respect to the first chamber of the fluid actuator and the second chamber of the fluid actuator is stopped and there is no regulation of the fluid flow through the valve, and
the controller controls the operational speed of the pump by setting the operational speed of the pump at a zero (0) value.

18. A hauling machine, comprising:
a frame and a dump body supported on the frame;
a hoisting mechanism for moving the dump body between a rest condition and a raised condition relative to the frame, the hoisting mechanism including:
a fluid actuator pivotally coupled to the frame and the dump body and actuatable to move the dump body with respect to the frame;
a valve configured to facilitate a selective fluid flow with respect to a first chamber and a second chamber of the fluid actuator to actuate the fluid actuator;
a pump to provide a supply of the fluid flow to the valve; and
a system for controlling the hoisting mechanism of the hauling machine, the system including:
an input device configured to be moved to a desired input location of a plurality of input locations to generate a request, wherein corresponding requests are generated when the input device moves to the plurality of input locations;
a controller configured to:
receive the request to vary the dump body between the rest condition and the raised condition;
determine a criteria for actuating the hoisting mechanism corresponding to the request, the criteria including an actuation direction and an actuation speed for the fluid actuator;
move the valve to a predefined position based on the actuation direction to set a direction of movement of the dump body between the rest condition and the raised condition; and
control each of a state of the valve in the predefined position of the valve and an operational speed of the pump based on the actuation speed to set a rate of movement of the dump body along the direction of movement.

19. The hauling machine of claim 18, wherein
the input device is configured to be moved to at least four (4) discrete input locations of the plurality of input locations and to multiple intermediate input locations of the plurality of input locations defined between at least two discrete input locations of the at least four (4) discrete input locations,
the four (4) discrete input locations includes a first input location, a second input location, a third input location, and a fourth input location, and
to move the valve to the predefined position, the controller is configured to shift the valve between four (4) discrete valve positions including: a first valve position, a second valve position, a third valve position, and a fourth valve position when the input device is correspondingly moved to the first input location, the second input location, the third input location, and the fourth input location.

20. The hauling machine of claim 19, wherein
the valve is configured to be moved to the first valve position, the second valve position, the third valve position, and the fourth valve position, to selectively and correspondingly enable lower, hold, float, and raise functions, of the dump body with respect to the frame, and
to control the state of the valve in the predefined position of the valve, the controller is configured to:
regulate a flow of fluid through the valve in one of the first valve position, the second valve position, and the fourth valve position, to which the valve is shifted, correspondingly when the input device moves or varies between the first input location and the second input location, the second input location and the third input location, and the third input location and the fourth input location, and
stop the flow of fluid through the valve in the third valve position to which the valve is shifted when the input device moves to the third input location.
